(19) United States
(12) Patent Application Publication
(10) Pub. No.: US 2023/0372872 A1
(43) Pub. Date: Nov. 23, 2023

(54) SUPPORT DEVICE, SUPPORT METHOD, AND SUPPORT PROGRAM

(71) Applicant: Yokogawa Electric Corporation, Tokyo (JP)

(72) Inventors: Yasuhiro MATSUI, Musashino-shi (JP); Ryota KIMURA, Musashino-shi (JP); Hideki YOSHIDA, Musashino-shi (JP)

(21) Appl. No.: 18/030,927

(22) PCT Filed: Sep. 14, 2021
(86) PCT No.: PCT/JP2021/033752

§ 371 Date: Apr. 7, 2023

(30) Foreign Application Priority Data
Oct. 14, 2020 (JP) 2020-173200

(51) Int. Cl. B01D 61/22; C02F 1/44; B01D 61/12; B01D 65/06

(52) U.S. Cl. CPC B01D 61/22; C02F 1/444; C02F 1/441; B01D 61/12; B01D 65/06

(57) ABSTRACT

A support device includes an acquirer configured to acquire data indicating water quality information of water to be treated, a pressure to supply the water to be treated to a membrane filtration device, a transmembrane pressure at a filtration membrane, a permeation flux at the filtration membrane, a frequency and cleaning conditions for cleaning the filtration membrane with cleaning water, and an outputter configured to output an optimum value of a current permeation flux, and a frequency and cleaning conditions for cleaning the membrane filtration device with the cleaning water in the future based on the data indicating the water quality information of the water to be treated, the pressure to supply the water to be treated to the membrane filtration device, and the transmembrane pressure at the filtration membrane, that have been acquired by the acquirer, by using a learned determination model acquired by performing learning processing using the data acquired by the acquirer.

### TECHNICAL FIELD

The present invention relates to a support device, a support method, and a support program for supporting an operation manager of a water treatment apparatus having a membrane filtration device with a filtration membrane.

### BACKGROUND ART

In recent years, the importance of a water treatment system using a membrane filtration device has particularly increased. A system using a membrane filtration device has advantages of high stability of treated water quality and using a small amount of chemicals during water treatment or not requiring chemicals.

In a water treatment system using a membrane filtration device, impurities contained in water (for example, solids such as particles, algae or aquatic organisms and metabolites derived therefrom, organic or inorganic dissolved substances such as silica and calcium) may precipitate on a membrane surface and cause clogging at the membrane. If such membrane clogging occurs, either excessive energy is required to secure treated water, or excessive pressure causes damage to the system, which makes it impossible to perform normal water treatment. For this reason, the operation mode is switched from a filtration mode for treating water to a cleaning mode for cleaning a membrane to clear clogging of the membrane, and cleaning of the membrane is periodically performed.

Patent Document 1 below discloses an example of a conventional membrane filtration system. Specifically, a membrane filtration system that includes a global aeration system that physically cleans a membrane module of the membrane filtration system, and controls an operation of the global aeration system according to a signal from a flow sensor is disclosed.

### CITATION LIST

### Patent Document

[Patent Document 1]
Published Japanese Translation No. 2012-528717 of the PCT International Publication

### SUMMARY OF INVENTION

### Technical Problem

Incidentally, valve opening and closing operations or motor operation or stop corresponding to an operation mode of the water treatment system described above, and trigger conditions (time, pressure) for control of these operations are set by a designer before the water treatment system is introduced. The designer should consider the maximum amount and the water quality of water to be treated that the water treatment system can allow to perform design. The allowable maximum amount and water quality of water to be treated are designed assuming high-load water quality that allows operation of the membrane filtration device, even in the midst of annual fluctuations in water quality.

However, an annual frequency of processing raw water with such a high load of water quality is low. The water quality that imposes a high load on the membrane filtration device is caused by, for example, contamination of water containing impurities during bad weather, metabolism of algae and the like that occur in water areas, and unexpected accidents or illegal dumping in a basin sewage system. An allowable upper limit of water quality that is acceptable in the water treatment system is set in consideration of such a high load of raw water quality, an occurrence frequency, and a safety factor. Therefore, the operation and sequence of each valve or motor in each operation mode and a control sequence of these operation modes are excessively safe and conservative operations for stable water quality conditions of raw water for most of the year, resulting in an inefficient control concept from a viewpoint of energy saving.

In addition, preconditions required when the water treatment system is introduced often change after the introduction. External environmental factors, which are closely related to transition of population, weather conditions, and the water quality of the water to be treated, change over time, and it is assumed that optimum operation conditions at the time of introduction of the water treatment system will not necessarily be optimum in subsequent operations. In this manner, it is difficult to say that optimum water treatment is performed with large fluctuations in the water quality of the water to be treated in a conventional water treatment system.

The present invention has been made in view of the circumstances described above, and an object thereof is to provide a support device, a support method, and a support program that support an operation manager so that control for the optimum water treatment can be performed.

### Solution to Problem

The present invention has adopted the following configuration to solve the problems described above.

That is, a support device according to one aspect of the present invention is a support device for supporting an operation manager of a water treatment apparatus having a membrane filtration device with a filtration membrane. The support device may include: an acquirer configured to acquire data indicating water quality information of water to be treated, a pressure to supply the water to be treated to the membrane filtration device, a transmembrane pressure at the filtration membrane, a permeation flux at the filtration membrane, a frequency and cleaning conditions for cleaning the filtration membrane with cleaning water; and an outputter configured to output an optimum value of a current permeation flux, and a frequency and cleaning conditions for cleaning the membrane filtration device with the cleaning water in the future based on the data indicating the water quality information of the water to be treated, the pressure to supply the water to be treated to the membrane filtration device, and the transmembrane pressure at the filtration membrane, that have been acquired by the acquirer, by using a learned determination model acquired by performing learning processing using the data acquired by the acquirer.

In the support device according to one aspect of the present invention, the acquirer may be configured to further acquire data indicating a frequency for cleaning the filtration membrane with chemicals and information on chemicals to be used when the filtration membrane is cleaned with the chemicals, the determination model may be further obtained by performing learning processing using data indicating a frequency for cleaning the filtration membrane with chemicals and information on chemicals to be used when the filtration membrane is cleaned with the chemicals, and the outputter may be configured to further output a frequency for cleaning the membrane filtration device with chemicals in the future and information on chemicals to be used when the membrane filtration device is cleaned with the chemicals.

In the support device according to one aspect of the present invention, the support device may further include a learning section configured to acquire the determination model by performing the learning processing using the data acquired by the acquirer.

In the support device according to one aspect of the present invention, the cleaning conditions may include supply pressure of cleaning water when the membrane filtration device is cleaned with cleaning water.

In the support device according to one aspect of the present invention, the determination model may be a model for determining a frequency at which online chemical cleaning or offline chemical cleaning needs to be performed on the membrane filtration device in the future, and information on chemicals to be used when the online chemical cleaning or the offline chemical cleaning is performed on the membrane filtration device.

In the support device according to one aspect of the present invention, the determination model may be a model for determining a time at which the filtration membrane of the membrane filtration device needs to be replaced.

In the support device according to one aspect of the present invention, the outputter may be configured to output a graph indicating a relationship between a number of days of filtration and the transmembrane pressure as support information.

A support method according to another aspect of the present invention is a support method for supporting an operation manager of a water treatment apparatus having a membrane filtration device with a filtration membrane. The support method may include: an acquiring step of acquiring data indicating water quality information of water to be treated, a pressure to supply the water to be treated to the membrane filtration device, a transmembrane pressure at the filtration membrane, a permeation flux at the filtration membrane, a frequency and cleaning conditions for cleaning the filtration membrane with cleaning water; and an outputting step of outputting an optimum value of a current permeation flux, and a frequency and cleaning conditions for cleaning the membrane filtration device with cleaning water in the future based on the data indicating the water quality information of the water to be treated, the pressure to supply the water to be treated to the membrane filtration device, and the transmembrane pressure at the filtration membrane, that have been acquired in the acquiring step, by using a learned determination model acquired by performing learning processing using the data acquired in the acquiring step.

In the support method according to another aspect of the present invention, the acquiring step may include further acquiring data indicating a frequency for cleaning the filtration membrane with chemicals and information on chemicals to be used when the filtration membrane is cleaned with the chemicals, the determination model may be further obtained by performing learning processing using data indicating a frequency for cleaning the filtration membrane with chemicals and information on chemicals to be used when the filtration membrane is cleaned with the chemicals, and the outputting step may include further outputting a frequency for cleaning the membrane filtration device with chemicals in the future and information on chemicals to be used when the membrane filtration device is cleaned with the chemicals.

In the support method according to another aspect of the present invention, the support method may further include a learning step of acquiring the determination model by performing the learning processing using the data acquired in the acquiring step.

In the support method according to another aspect of the present invention, the cleaning conditions may include supply pressure of cleaning water when the membrane filtration device is cleaned with cleaning water.

In the support method according to another aspect of the present invention, the determination model may be a model for determining a frequency at which online chemical cleaning or offline chemical cleaning needs to be performed on the membrane filtration device in the future, and information on chemicals to be used when the online chemical cleaning or the offline chemical cleaning is performed on the membrane filtration device.

In the support method according to another aspect of the present invention, the determination model may be a model for determining a time at which the filtration membrane of the membrane filtration device needs to be replaced.

In the support method according to another aspect of the present invention, the outputting step may include outputting a graph indicating a relationship between a number of days of filtration and the transmembrane pressure as support information.

A support program according to still another aspect of the present invention is a support program for causing a computer of a support device for supporting an operation manager of a water treatment apparatus having a membrane filtration device with a filtration membrane to execute: an acquiring step of acquiring data indicating water quality information of water to be treated, a pressure to supply the water to be treated to the membrane filtration device, a transmembrane pressure at the filtration membrane, a permeation flux at the filtration membrane, a frequency and cleaning conditions for cleaning the filtration membrane with cleaning water; and an outputting step of outputting an optimum value of a current permeation flux, and a frequency and cleaning conditions for cleaning the membrane filtration device with cleaning water in the future based on the data indicating the water quality information of the water to be treated, the pressure to supply the water to be treated to the membrane filtration device, and the transmembrane pressure at the filtration membrane, that have been acquired in the acquiring step, by using a learned determination model acquired by performing learning processing using the data acquired in the acquiring step.

In the support program according to still another aspect of the present invention, the acquiring step may include further acquiring data indicating a frequency for cleaning the filtration membrane with chemicals and information on chemicals to be used when the filtration membrane is cleaned with the chemicals, the determination model may be further obtained by performing learning processing using data indicating a frequency for cleaning the filtration membrane with chemicals and information on chemicals to be used when the filtration membrane is cleaned with the chemicals, and the outputting step may include further outputting a frequency for cleaning the membrane filtration device with chemicals in the future and information on chemicals to be used when the membrane filtration device is cleaned with the chemicals.

In the support program according to still another aspect of the present invention, the support program may further cause the computer to execute a learning step of acquiring the determination model by performing the learning processing using the data acquired in the acquiring step.

In the support program according to still another aspect of the present invention, the cleaning conditions may include supply pressure of cleaning water when the membrane filtration device is cleaned with cleaning water.

In the support program according to still another aspect of the present invention, the determination model may be a model for determining a frequency at which online chemical cleaning or offline chemical cleaning needs to be performed on the membrane filtration device in the future, and information on chemicals to be used when the online chemical cleaning or the offline chemical cleaning is performed on the membrane filtration device.

In the support program according to still another aspect of the present invention, the determination model may be a model for determining a time at which the filtration membrane of the membrane filtration device needs to be replaced.

### Advantageous Effects of Invention

According to one aspect of the present invention, there is an effect that it is possible to support an operation manager so that the control for optimum water treatment can be performed.

### BRIEF DESCRIPTION OF DRAWINGS

FIG. 1 is a schematic diagram which shows a configuration example of a water treatment system.

FIG. 2 is a schematic diagram for describing a filtration mode.

FIG. 3 is a schematic diagram for describing a backwash mode.

FIG. 4 is a schematic diagram for describing a cleaning mode using chemicals.

FIG. 5 is a schematic diagram for describing an operation preparation mode.

FIG. 6 is a block diagram which shows a configuration of a main part of a support device.

FIG. 7 is an example of a method of generating a determination model on the basis of an experimental design method.

FIG. 8 is an example of support information displayed on a display.

FIG. 9 is a flowchart at the time of learning.

FIG. 10 is a flowchart at the time of operation.

### DESCRIPTION OF EMBODIMENTS

[Outline]

In recent years, according to increases in population and improvements in living standards, consumption of clean water has increased, which has resulted in a shortage of water resources. In addition, water quality of rivers and wastewater is deteriorating, and there is an urgent need for countermeasures all over the world. For example, for the purpose of sustainable use of water resources, projects for using reclaimed water are being considered.

Water treatment is generally divided into a primary treatment, a secondary treatment, and a tertiary treatment.

The primary treatment is a treatment of removing large waste (SS: suspended solids; specifically, solids in sewage mixed with manure).

The secondary treatment is a treatment of removing organic substances in the sewage that could not be removed in the primary treatment using an action of microorganisms. It also includes chemical, physical, and biological methods to remove nitrogen, phosphorus, persistent substances, and the like from nutrient salt. Specifically, a simple aeration treatment, an activated sludge treatment, a nitrification-denitrification reaction treatment, and the like are performed.

In the tertiary treatment, solid-liquid separation and turbidity control are performed using a filtration medium such as filter sand or anthracite to remove suspended solids that could not be eliminated in the secondary treatment.

A chemical treatment may be introduced for the secondary treatment and the tertiary treatment described above. Contaminant separation using a coagulant or the like, contaminant decomposition using an oxidizing agent such as ozone, and the like are examples.

Similarly, a physical treatment may be introduced for the secondary treatment and the tertiary treatment, including separation by a membrane treatment.

As membranes used for separation by the membrane treatment, reverse osmosis membranes (RO membranes), ultrafiltration membranes (UF membranes), microfiltration membranes (MF membranes), and the like are used.

In a water treatment system using a membrane filtration device having the membrane described above, impurities contained in water to be treated (for example, microorganisms, organic substances, and inorganic substances such as silica, calcium, iron and manganese) may be deposited on a surface of the membrane and cause membrane clogging to occur. Once such membrane clogging occurs, normal water treatment cannot be performed. For this reason, an operation mode is switched from a filtration mode for treating the water to be treated to a cleaning mode for cleaning the membrane to clear membrane clogging and the like, and cleaning of the membrane is performed periodically.

Specifically, examples of membrane cleaning methods include physical cleaning of cleaning a membrane with a physical shearing force. Examples of the physical cleaning specifically include a method of cleaning with a water-hammer-like shearing force generated by contact between pressurized water and a membrane. Moreover, in this method, compressed air may be exposed on a supply water side of a membrane to clean the membrane by vibration or an air bubble shearing action to enhance a cleaning effect.

On the other hand, the optimum conditions and frequency for membrane cleaning change depending on the water quality of the water to be treated. However, it is not common for an end user to change the conditions and frequency for membrane cleaning initially set by a designer.

The water treatment system described in Patent Document 1 uses signals acquired from a flow sensor and a pressure sensor in water treatment to control physical cleaning using a global aeration system. However, there are a wide variety of elements for performing optimum physical cleaning, and it is difficult to optimize the cleaning only with a flow rate and a pressure. Moreover, in optimizing the water treatment system, controlling physical cleaning alone is not enough.

The support device of the present embodiment is a support device for supporting an operation manager of a water treatment apparatus having a membrane filtration device with a filtration membrane. The support device includes an acquirer that acquires data indicating water quality information of the water to be treated, a pressure to supply the water to be treated to the membrane filtration device, a transmembrane pressure at the filtration membrane, a permeation flux at the filtration membrane, a frequency and cleaning conditions for cleaning the filtration membrane with cleaning water, and an outputter that outputs the optimum value of a current permeation flux, and a frequency and cleaning conditions for cleaning the membrane filtration device with cleaning water in the future based on the data indicating the water quality information of the water to be treated, the pressure to supply the water to be treated to the membrane filtration device, and the transmembrane pressure at the filtration membrane, that have been acquired by the acquirer, by using a learned determination model acquired by performing learning processing using the data acquired by the acquirer. According to the support device of the present embodiment, it is possible to support the operation manager so that control for optimum water treatment can be performed.

A support device, a support method, and a support program according to embodiments of the present invention will be described below with reference to the drawings.

<Water Treatment System>

First, a configuration example of a water treatment system according to the present embodiment will be described.

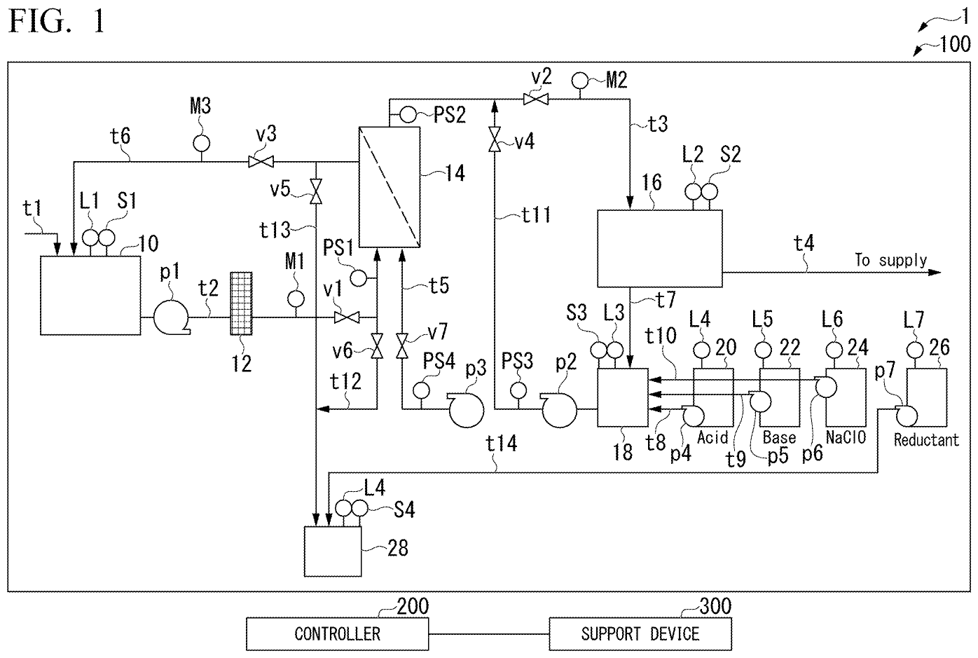

FIG. 1 is a schematic diagram which shows one configuration example of a water treatment system 1 according to the present embodiment.

The water treatment system 1 includes a water treatment apparatus 100, a controller 200, and a support device 300.

The water treatment apparatus 100 and the controller 200 are connected to be able to communicate with each other via a network. The network is composed of, for example, a local area network (LAN), a dedicated line, or a combination of these. Also, the network may be wireless or wired.

The controller 200 receives process data acquired from each device that constitutes the water treatment apparatus 100 to be described below, and controls each device that constitutes the water treatment apparatus 100 on the basis of the process data.

The controller 200 and the support device 300 are connected to be able to communicate with each other via a network. The network is composed of one or a combination of the Internet, a public communication network, a local area network (LAN), and a dedicated line. Also, the network may be wireless or wired.

The support device 300 analyzes the process data received by the controller 200 and outputs optimum operation conditions. Details of a configuration and an operation of the support device 300 will be described below.

<Water Treatment Apparatus>

Details of each constituent of the water treatment apparatus 100 will be described using FIG. 1.

The water treatment apparatus 100 includes a feed tank 10, a strainer 12, a membrane filtration device 14, a filtrate tank 16, a chemical solution tank 18, an acid component tank 20, a basic component tank 22, a sodium hypochlorite tank 24, a reducing agent tank 26, and a waste liquid tank 28.

The feed tank 10 includes a level sensor L1 and a water quality sensor S1. The level sensor L1 is a sensor that measures a water level of water to be treated in the feed tank 10.

The water quality sensor S1 is a sensor that measures water quality of the water in the feed tank 10.

Examples of water quality include turbidity, pH, electrical conductivity, water temperature, transmittance of ultraviolet rays with a wavelength of 254 nm (UV₂₅₄), residual chlorine (free chlorine or combined chlorine), total organic carbon (TOC), species such as algae, cyanobacteria, plankton, and protozoa, and concentration information thereof.

Examples of the water quality sensor S1 include a turbidity meter, a pH meter/ORP meter, an electrical conductivity meter, a spectrophotometer, a residual chlorine meter, a total organic carbon concentration meter, and the like.

More specifically, examples of the turbidity meter include a transmission scattering type turbidity meter (TB700G, manufactured by Yokogawa Electric Corporation), a surface scattering type turbidity meter (TB400G, manufactured by Yokogawa Electric Corporation), and the like.

More specifically, examples of the pH meter/ORP meter include a pH/ORP liquid analyzer (FLXA402 or FLXA202, manufactured by Yokogawa Electric Corporation).

More specifically, examples of the electrical conductivity meter include an electromagnetic conductivity liquid analyzer (FLXA402 or FLXA202, manufactured by Yokogawa Electric Corporation). The electromagnetic conductivity liquid analyzer can also measure water temperature.

More specifically, examples of the spectrophotometer include an ultraviolet-visible detector (UV-254 LA, manufactured by Nippon Analytical Industry Co., Ltd.).

More specifically, examples of the residual chlorine meter include a free chlorine meter (FC400G, manufactured by Yokogawa Electric Corporation), a residual chlorine meter (RC400G, manufactured by Yokogawa Electric Corporation), and the like.

More specifically, examples of the total organic carbon concentration meter include an online TOC analyzer (TOC-4200, manufactured by Shimadzu Corporation).

With a measurement device for underwater microorganisms such as algae, cyanobacteria, and protozoa, it is possible to identify a biological species using optical and image recognition technologies for underwater microorganisms of 1 μm or more (FlowCam Cyano, manufactured by Yokogawa Fluid Imaging Technologies).

The feed tank 10, the strainer 12, and the membrane filtration device 14 are connected in that order from upstream by a pipe t2. In the pipe t2, a feed pump p1 is provided between the feed tank 10 and the strainer 12, and a flow meter M1, a valve v1, and a supply water pressure gauge PS1 are provided from upstream between the strainer 12 and the membrane filtration device 14.

In addition, the feed tank 10 and the membrane filtration device 14 are connected by a pipe t6. The pipe t6 includes a valve v3 and a flow meter M3.

The strainer 12 is a net-shaped member used to remove solid components from the water to be treated.

Specifically, examples of a filtration membrane included in the membrane filtration device 14 include a reverse osmosis membrane (RO membrane), an ultrafiltration membrane (UF membrane), a microfiltration membrane (MF membrane), and the like, but among them, the UF membrane or the MF membrane that switches between the filtration mode and the cleaning mode and has a complicated operation of a mechanical device is preferable.

Examples of membrane materials of the UF membrane and the MF membrane can include organic materials such as polyethylene (PE), polypropylene (PP), polyvinylidene fluoride (PVDF), polyacrylonitrile (PAN), polyethersulfone (PES), polysulfone (PS), cellulose acetate (CA), and inorganic materials such as ceramics and metals.

Examples of a form of the UF membrane and the MF membrane include hollow fibers, tubulars, and flat membranes.

The membrane filtration device 14 is connected to a blower p3 by a pipe t5. The pipe t5 includes a pressure gauge PS4 and a valve v7.

The membrane filtration device 14 and the filtrate tank 16 are connected by a pipe t3. In the pipe t3, a filtered water pressure gauge PS2, a valve v2, and a flow meter M2 are provided from a membrane filtration device 14 side.

A difference value between a value measured by the supply water pressure gauge PS1 and a value measured by the filtered water pressure gauge PS2 described above is monitored as a transmembrane pressure (TMP).

In addition, a flow rate (permeation flux) of water per membrane area per unit time is monitored based on a value measured by the flow meter M1 and a value measured by the flow meter M2 described above.

The filtrate tank 16 includes a level sensor L2 and a water quality sensor S2.

The level sensor L2 is a sensor that measures a water level of the filtered water in the filtrate tank 16.

Examples of the water quality sensor S2 include the same sensor as the water quality sensor S1 described above.

The filtrate tank 16 and the chemical solution tank 18 are connected by a pipe t7.

The chemical solution tank 18 and the acid component tank 20 are connected by a pipe t8. In addition, the pipe t8 has an acid component supply pump p4.

The acid component tank 20 includes a level sensor L4. The level sensor L4 is a sensor that measures a water level of an acid component in the acid component tank 20. Examples of the acid component include sulfuric acid, hydrochloric acid, citric acid, oxalic acid, and the like.

The chemical solution tank 18 and the basic component tank 22 are connected by a pipe t9. In addition, the pipe t9 includes a basic component supply pump p5.

The basic component tank 22 has a level sensor L5. The level sensor L5 is a sensor that measures a water level of a basic component in the basic component tank 22. Examples of the basic component include sodium hydroxide (sodium hydroxide aqueous solution), and the like.

The chemical solution tank 18 and the sodium hypochlorite tank 24 are connected by a pipe t10. The pipe t10 also includes a sodium hypochlorite supply pump p6.

The sodium hypochlorite tank 24 includes a level sensor L6. The level sensor L6 is a sensor that measures a water level of sodium hypochlorite (a sodium hypochlorite aqueous solution) in the sodium hypochlorite tank 24.

The chemical solution tank 18 includes a level sensor L3 and a water quality sensor S3.

The level sensor L3 is a sensor that measures a water level of filtered water in the chemical solution tank 18; the water level of the filtered water containing an acid component, a basic component, or sodium hypochlorite.

Examples of the water quality sensor S3 include the same sensor as the water quality sensor S1 described above.

The chemical solution tank 18 and the membrane filtration device 14 are connected by a pipe t11 and a pipe t3. The chemical solution tank 18 is connected to the pipe t11, and the pipe t11 includes a cleaning water supply pump p2 and a cleaning water pressure gauge PS3. In addition, the pipe t11 has a valve v4 at an end of pipe t3.

There are cases in which pipes t8, t9, and t10 are directly connected to t11 without the chemical solution tank 18 and the cleaning water supply pump p2.

The waste liquid tank 28 and the membrane filtration device 14 are connected by a pipe t13 and a pipe t6. The pipe t13 connected to the waste liquid tank 28 has a valve v5 at an end of the pipe t6.

In addition, the waste liquid tank 28 and the membrane filtration device 14 are connected by a pipe t12 and a pipe t13. The pipe t12 connected to the membrane filtration device 14 has a valve v6.

The waste liquid tank 28 and the reducing agent tank 26 are connected by a pipe t14. In addition, the pipe t14 includes a reducing agent supply pump p7.

The reducing agent tank 26 includes a level sensor L7. The level sensor L7 is a sensor that measures a water level of a reducing agent in the reducing agent tank 26.

The waste liquid tank 28 includes a level sensor L4 and a water quality sensor S4.

The level sensor L4 is a sensor that measures a water level of a waste liquid in the waste liquid tank 28.

Examples of the water quality sensor S4 include the same sensor as the water quality sensor S1 described above.

Next, an operation of the water treatment apparatus 100 will be described.

Examples of the operation modes of the water treatment apparatus 100 include a filtration mode, a backwash mode, a cleaning mode using chemicals (a maintenance cleaning mode), and an operation preparation mode (a preparation mode).

[Filtration Mode]

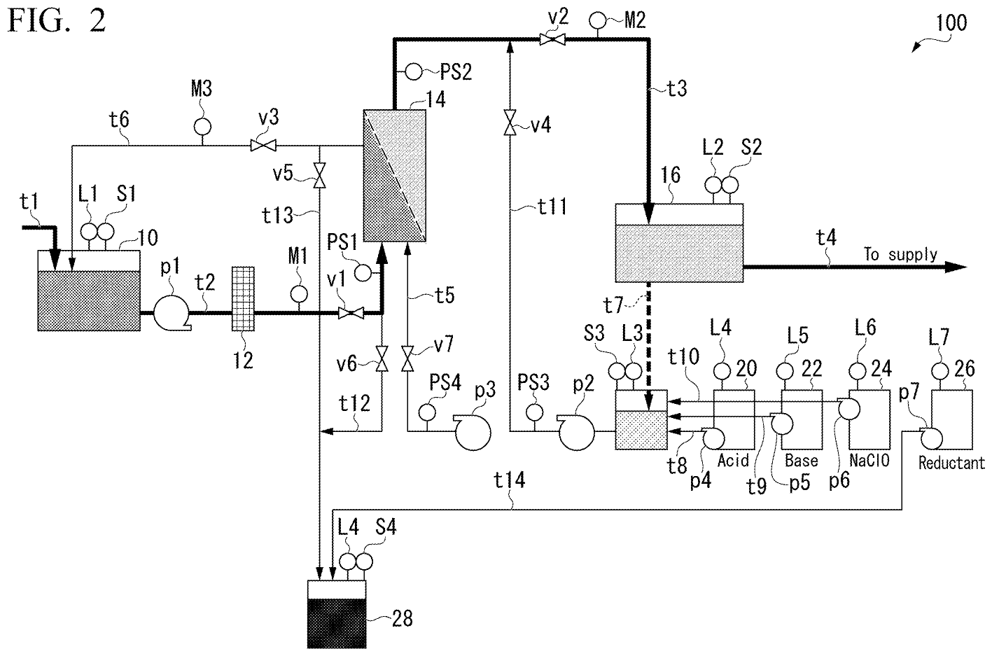

FIG. 2 is a schematic diagram for describing the filtration mode.

The filtration mode is a process of filtering water using the membrane filtration device 14 equipped with a filtration membrane.

In the filtration mode, the water to be treated is first stored in the feed tank 10 through the pipe t1.

Here, examples of the water to be treated include sewage, reused sewage, night soil, industrial wastewater, and leachate from garbage landfill sites, as well as general environmental water such as groundwater, rainwater, river water, and lake water. Moreover, seawater, brackish water, and the like with a high salt concentration are also included. These types of water to be treated generally contain dissolved substances and insoluble impurities such as calcium ions, magnesium ions, sodium ions, silica (ionic silica, colloidal silica), chloride ions, carbonate ions.

Next, the water to be treated is supplied to the membrane filtration device 14 through the pipe t2 by the feed pump p1 after the solid components are removed by the strainer 12. The water to be treated supplied to the membrane filtration device 14 is filtered by the filtration membrane and discharged from the membrane filtration device 14 as filtered water.

A water pressure when the water to be treated is supplied to the membrane filtration device 14 is measured by the supply water pressure gauge PS1. Moreover, a water pressure when the filtered water is discharged from the membrane filtration device 14 is measured by the filtered water pressure gauge PS2.

In addition, a flow rate when the water to be treated is supplied to the membrane filtration device 14 is measured by the flow meter M1. In addition, a flow rate when the filtered water is discharged from the membrane filtration device 14 is measured by the flow meter M2.

Based on these flow rate values, a rotation speed of the feed pump p1 is controlled so that a flow rate (permeation flux) of the water to be treated per membrane area per unit time is a constant value.

The filtered water discharged from the membrane filtration device 14 is stored in the filtrate tank 16 through the pipe t3. The filtered water stored in the filtrate tank 16 is discharged out of the apparatus through a pipe t4. In addition, some of the filtered water stored in the filtrate tank 16 is stored in the chemical solution tank 18 when necessary.

[Backwash Mode]

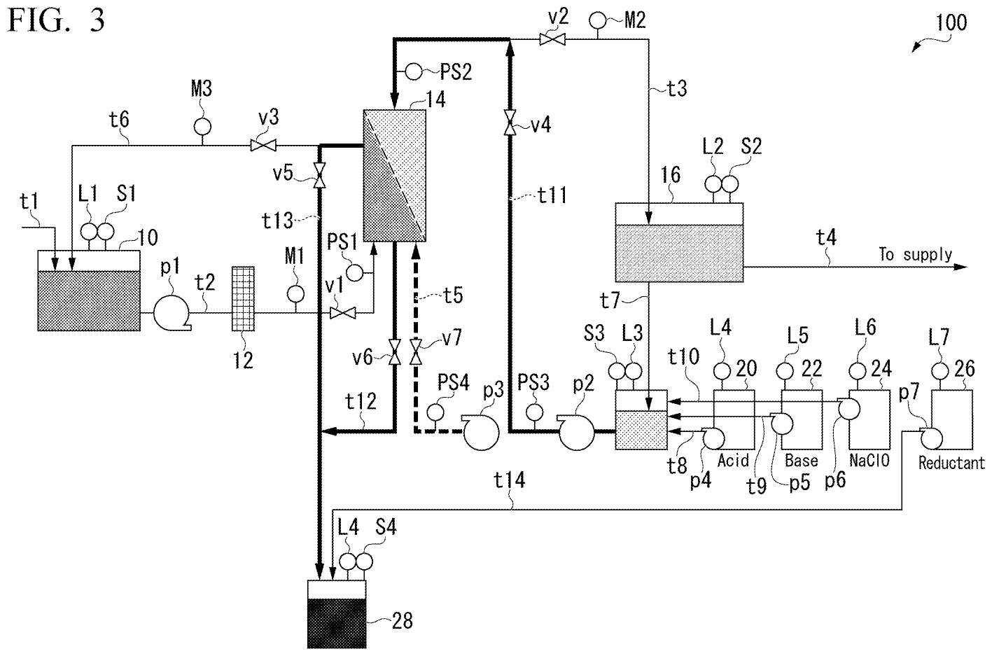

FIG. 3 is a schematic diagram for describing a backwash mode.

The backwash mode is a mode in which the filtered water stored in the filtrate tank 16 is pressurized by the cleaning water supply pump p2 and supplied to a filtration membrane provided in the membrane filtration device 14, thereby the filtration membrane is cleaned with physical shearing force.

In the backwash mode, the filtration membrane provided in the membrane filtration device 14 is cleaned with the pressurized filtered water without using chemicals.

In the backwash mode, by supplying filtered water from a permeation side and/or a supply side of the filtration membrane provided in the membrane filtration device 14, it is possible to clear or reduce clogging of the filtration membrane that has progressed in the filtration mode described above.

For example, the filtration mode is switched to the backwash mode by using an elapsed time of the filtration mode (filtration time), the rotation speed of the feed pump p1, and an increase in TMP as a trigger.

In the backwash mode, to enhance the effect of physical cleaning, the blower p3 may cause the filtration membrane provided in the membrane filtration device 14 to expose compressed air, and perform cleaning according to a vibration action of the membrane and a shearing action of air bubbles.

[Cleaning Mode Using Chemicals]

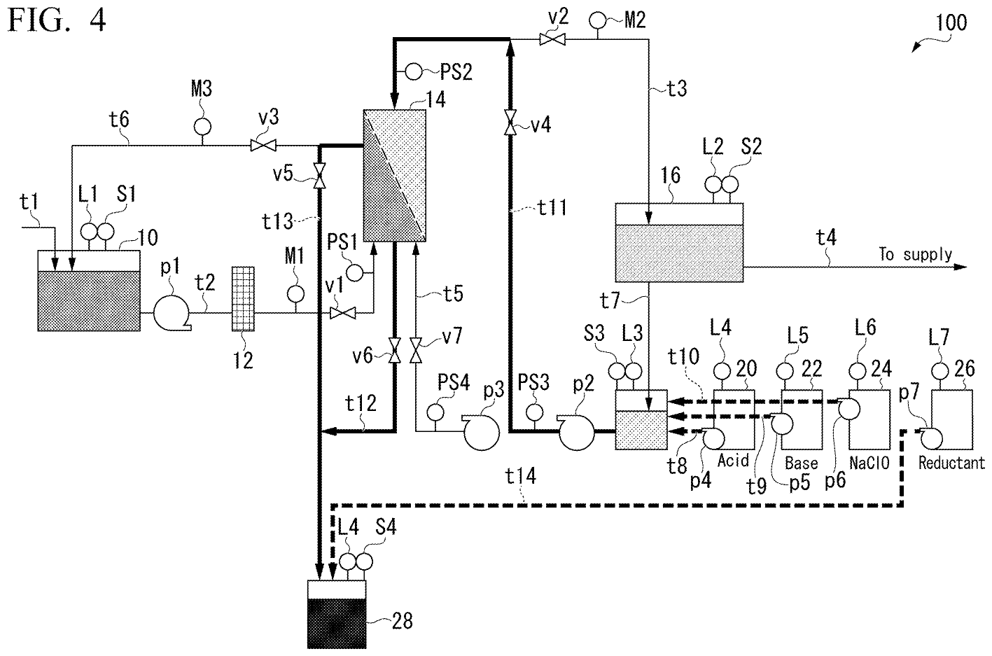

FIG. 4 is a schematic diagram for describing the cleaning mode using chemicals.

The cleaning mode using chemicals is a mode in which clogging substances adhering to a surface or pores of the filtration membrane provided in the membrane filtration device 14, which have progressed chronically, are eliminated in repeated operations of the filtration mode and the backwash mode.

Examples of the chemicals include an acid component, a basic component, and a sodium hypochlorite aqueous solution, and chemicals to be used are selected according to a cleaning purpose.

For example, when contamination with substances derived from microorganisms is cleaned, it is effective to use the sodium hypochlorite aqueous solution.

In addition, when contamination with the substances derived from microorganisms and organic substances is progressing more seriously, it is further effective to use a basic component in the sodium hypochlorite aqueous solution.

Moreover, when contamination with inorganic substances, for example, precipitation of hardness components and contamination with crystals of metal ions, is cleaned, it is effective to use an acid component.

Examples of the basic component include, for example, sodium hydroxide (sodium hydroxide aqueous solution), and the like. Examples of the acid component include, for example, sulfuric acid, hydrochloric acid, citric acid, oxalic acid, and the like.

In the cleaning mode using chemicals, first, one or more chemical solutions selected from a group consisting of an acid component, a basic component, and a sodium hypochlorite aqueous solution are added to the chemical solution tank 18, and filtered water containing the chemical solutions is prepared. Next, the filtered water containing the chemical solutions is supplied to the filtration membrane provided in the membrane filtration device 14 by the cleaning water supply pump p2, and the filtration membrane is immersed and cleaned.

Waste liquid used for cleaning the filtration membrane is stored in the waste liquid tank 28. A reducing agent (an aqueous solution such as sodium bisulfite, sodium thiosulfate, and the like) stored in a reducing agent pump 26 is added to the waste liquid stored in the waste liquid tank 28 by the reducing agent supply pump p7, and the waste liquid is neutralized. The neutralized waste liquid is discarded.

For example, after the filtration mode and the backwash mode are performed a certain number of times, they are switched to the cleaning mode using chemicals.

[Operation Preparation Mode]

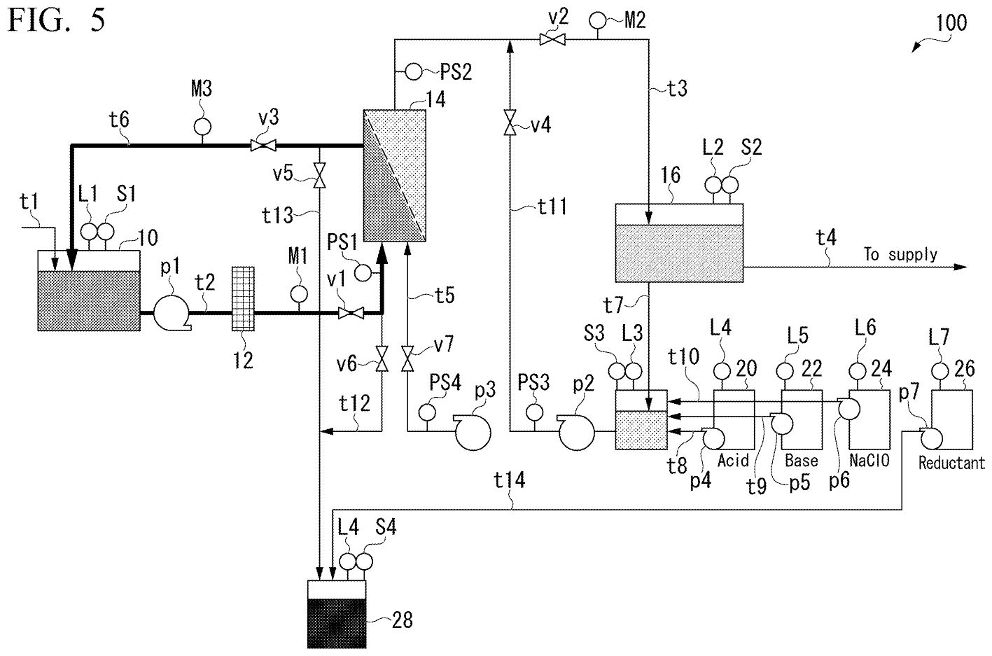

FIG. 5 is a schematic diagram for describing the operation preparation mode.

The operation preparation mode is a mode in which, after performing the backwash mode or the cleaning mode using chemicals, the water to be treated is caused to circulate in the membrane filtration device 14, air is removed from the membrane filtration device 14, and a pressure applied to the water to be treated is made uniform.

In the operation preparation mode, the water to be treated is caused to circulate between the feed tank 10 and the membrane filtration device 14 by the feed pump p1. The circulating water to be treated does not pass through the filtration membrane provided in the membrane filtration device 14, but flows on the surface of the filtration membrane.

Since the operation preparation mode also has an effect of physical cleaning, it may be incorporated as a part of an operation sequence in the backwash mode described above.

Table 1 shows opening or closing of a valve (o: open, c: closed) and an operation or stop of a pump (o: operation, c: stop, c/o: operation as necessary) corresponding to the operation modes of the water treatment apparatus 100 described above.

TABLE 1

| | v1 | v2 | v3 | v4 | v5 | v6 | v7 | p1 | p2 | p3 | p4 | p5 | p6 | p7 |
|---|---|---|---|---|---|---|---|---|---|---|---|---|---|---|
| Filtration | o | o | c | c | c | c | c | o | c | c | c | c | c | c |
| Mode | | | | | | | | | | | | | | |
| Backwash | c | c | c | o | o | o | o | c | o | o | c | c | c | c |
| Mode | | | | | | | | | | | | | | |
| Maintenance | c | c | c | o | o | o | c | c | o | c | c/o | c/o | c/o | c/o |
| Cleaning Mode | | | | | | | | | | | | | | |
| Preparation | o | c | o | c | c | c | c | o | c | c | c | c | c | c |
| Mode | | | | | | | | | | | | | | |

The controller 200 controls the opening and closing of a valve and the operation or stop of a pump corresponding to the operation mode.

<<Controller>>

The controller 200 receives process data acquired from each device constituting the water treatment apparatus 100 described above, and controls each device constituting the water treatment apparatus 100 on the basis of the process data. The controller 200 stores the opening or closing of the valve and the operation or stop of the pump, trigger information related to each operation, and programs related to a control flow.

The controller 200 has a monitoring device (not shown). The monitoring device is, for example, a human machine interface (HMI) for an engineer to monitor an operation state of a process and to set various setting values for controlling the operation state. The monitoring device is connected to a network and receives output values, which are measured values indicating a state of each process of the water treatment apparatus 100, from each device constituting the water treatment apparatus 100 at a predetermined time interval (for example, one minute). The monitoring device has, for example, a display (not shown) that displays the measured values at each time point. The monitoring device includes an operation inputter (not shown) for setting a target value of a process, which is a control target, according to an operation.

<Support Device>

Hereinafter, details of the support device of the present embodiment will be described with reference to the drawings.

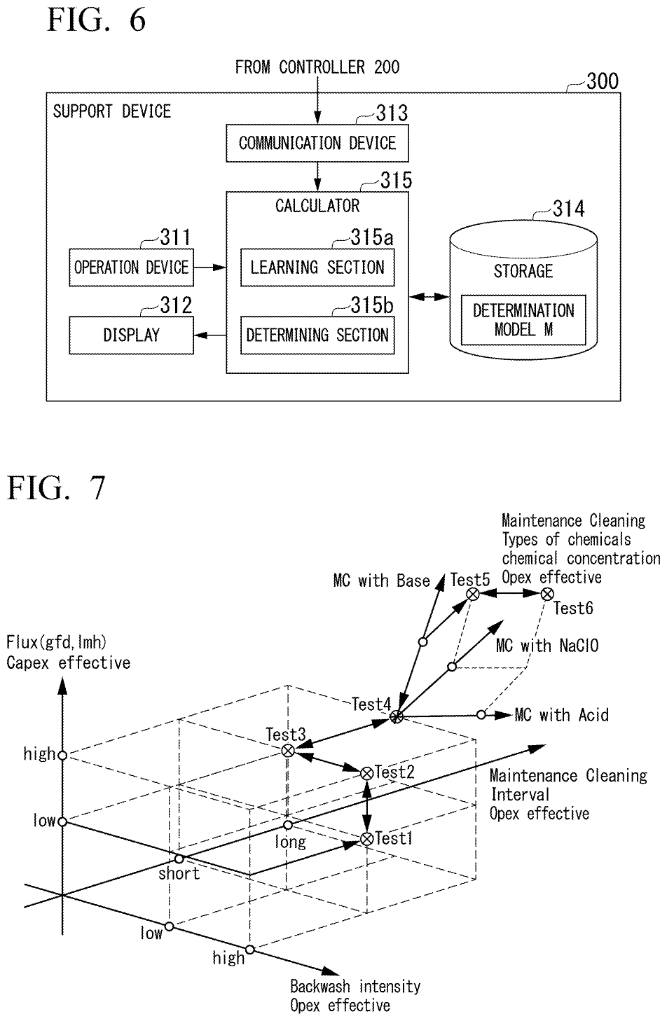

FIG. 6 is a block diagram which shows a configuration of a main part of the support device 300.

As shown in FIG. 6, the support device 300 includes an operation device 311, a display 312, a communication device 313, a storage 314, and a calculator 315. Such a support device 300 communicates with the controller 200 to acquire various types of information of the water treatment apparatus 100 and presents support information for supporting an operation manager who operates the water treatment apparatus 100.

The operation device 311 includes, for example, an input device such as a keyboard or a pointing device, and outputs an input signal to the calculator 315 according to an operation of the input device. The display 312 includes, for example, a display device such as a liquid crystal display device, and displays various types of information (for example, support information, and the like) output from the calculator 315. Note that the operation device 311 and the display 312 may be, for example, integrated like a touch panel type liquid crystal display device having both a display function and an operation function.

The communication device 313 communicates with the controller 200 to acquire various types of information on the water treatment apparatus 100.

Specifically, examples of the various types of information acquired by the communication device 313 include the water quality information of the water to be treated measured by the water quality sensor S1, a pressure to supply the water to be treated measured by the supply water pressure gauge PS1 to the membrane filtration device 14, a transmembrane pressure at the filtration membrane calculated based on the measured values of the supply water pressure gauge PS1 and filtered water pressure gauge PS2, a permeation flux in the filtration membrane calculated based on the measured value of the flow meter M1 or the flow meter M2 and an effective area of the filtration membrane (gallon/ft2/day, Liters/m2/hour, or m3/m2/day), a frequency of cleaning the filtration membrane with cleaning water (filtered water) (a frequency of the backwash mode), a supply pressure of cleaning water (filtered water) measured by the cleaning water pressure gauge PS3, an amount of water supplied to the membrane filtration device 14 by the cleaning water supply pump p2 in the backwash mode, an amount of compressed air for the blower p2 operating in the filtration mode, the backwash mode, or both modes, an air pressure of compressed air measured by the pressure gauge PS4, a frequency of the cleaning the filtration membrane with chemicals (a frequency of cleaning mode using chemicals), information on chemicals to be used when the filtration membrane is cleaned with the chemicals (types, concentrations, and the like of the chemicals), and the like.

More specifically, examples of the water quality information of the water to be treated include turbidity, pH, electrical conductivity, a water temperature, transmittance of ultraviolet rays with a wavelength of 254 nm (UV₂₅₄), residual chlorine (free chlorine and/or combined chlorine), total organic carbon (TOC), and information on types and concentrations of algae, cyanobacteria, plankton, protozoa, and the like.

The storage 314 has auxiliary storage devices such as a hard disk drive (HDD) and a solid state drive (SSD), and stores various data. The storage 314 stores, for example, various types of information acquired by the communication device 313 and a determination model (details will be described below) generated by a learning section 315a.

The calculator 315 performs various calculations using the information stored in the storage 314. The calculator 315 includes the learning section 315a and a determining section 315b. The learning section 315a uses the information stored in the storage 314 to learn a relationship between a plurality of pieces of data selected from the water quality information of the water to be treated, the pressure supplied to the membrane filtration device of the water to be treated, the transmembrane pressure, the permeation flux, the frequency of cleaning with cleaning water (filtered water) and cleaning conditions, the air pressure of compressed air, the frequency of cleaning the filtration membrane with chemicals, and the information on chemicals to be used when the filtration membrane is cleaned with the chemicals, and generates a determination model M for determining optimum operating conditions of the water treatment apparatus 100 from a viewpoint of energy saving. As a learning algorithm of the learning section 315a, various algorithms such as various regression analysis methods, decision trees, k nearest neighbors, neural networks, support vector machines, deep learning, and the like can be used. For example, the learning section 315a performs learning using a neural network to generate the determination model M having an input layer, an intermediate layer, and an output layer.

More specifically, examples of the determination model M include a determination model for learning the relationship between the water quality information of the water to be treated, the pressure to supply the water to be treated to the membrane filtration device, the transmembrane pressure, the permeation flux, the frequency of cleaning (physical cleaning) with cleaning water (filtered water), and the cleaning conditions, and determining an optimum value of a current permeation flux, and the frequency and cleaning conditions at which the membrane filtration device needs to be cleaned with cleaning water in the future based on the water quality information of the water to be treated, the pressure to supply the water to be treated to the membrane filtration device, and the transmembrane pressure at the filtration membrane.

The cleaning conditions for cleaning the membrane filtration device with cleaning water, that is, physical cleaning conditions for cleaning the membrane filtration device 14 in the backwash mode, may include an amount of cleaning water with respect to an amount of filtered water filtered by the membrane filtration device 14 in the filtration mode (cleaning water amount/filtered water amount), a supply pressure when cleaning is performed with cleaning water, a temperature of cleaning water, a cleaning time, and the like. In addition, whether the blower p2 is used in the backwash mode, and when the blower p2 is used, the amount of compressed air, the pressure of the compressed air, and the like may be included.

The optimum value of a current permeation flux is determined using the determination model described above, and thereby an operation manager can grasp a difference between a current permeation flux value and the optimum permeation flux value. As a result, even an operation manager who is unfamiliar with water treatment control can control the rotation speed of the feed pump p1 so that the permeation flux becomes the optimum value.

The optimum value of a permeation flux means the optimum value from the viewpoint of energy saving and membrane clogging. As the permeation flux increases, an amount of filtered and permeated water increases, but a power cost of the feed pump for supplying the water to be treated to the membrane filtration device increases. In addition, the permeation flux is associated with a progress of clogging of the filtration membrane provided in the membrane filtration device, and there is a possibility that the frequency of cleaning using physical cleaning and chemicals will increase. Easiness of recovery from membrane clogging by these cleanings differs depending on a degree of clogging of the filtration membrane, and it does not simply mean that it is better as the permeation flux increases.

If this membrane clogging can be easily recovered by physical cleaning or cleaning with chemicals, it remains a reversible membrane clogging, and a filtration operation rate will increase. On the other hand, in cleaning with chemicals, when there is no choice but to recover with high concentration and long-time chemicals immersion, it will progress to irreversible membrane clogging, and the filtration operation rate will decrease.

Such irreversible membrane clogging causes an increase in energy and chemical cost per amount of permeated water, as well as deterioration of membranes due to high concentration chemicals, and thus it results in uneconomical operation.

In addition, examples of the determination model M may also include a determination model for learning a relationship between the water quality information of the water to be treated, the pressure to supply the water to be treated to the membrane filtration device, the transmembrane pressure, the permeation flux, the frequency of cleaning with cleaning water (filtered water), a supply amount and a pressure of cleaning water (filtered water), the frequency of cleaning the filtration membrane with chemicals, and the information on chemicals to be used when the filtration membrane is cleaned with the chemicals, and determining the optimum value of a current permeation flux, the frequency and cleaning conditions at which the membrane filtration device needs to be cleaned with cleaning water in the future, the frequency at which the membrane filtration device needs to be cleaned with chemicals in the future, and information on chemicals to be used when the membrane filtration device is cleaned with the chemicals in the future based on the water quality information of the water to be treated, the pressure to supply the water to be treated to the membrane filtration device, and the transmembrane pressure at the filtration membrane. The information on chemicals includes types of chemicals, combinations of chemicals, concentrations of chemicals, and the like.

Using the determination model described above, the frequency at which the membrane filtration device needs to be cleaned with chemicals and the information on chemicals to be used when the membrane filtration device is cleaned with the chemicals in the future are determined, and thereby it is possible to reduce an amount of chemicals used and to greatly reduce the cost of water treatment.

Operations for cleaning the membrane filtration device with chemicals are not limited to the cleaning mode using chemicals described above, and include online chemical cleaning (Cleaning In Place: CIP), which is less frequent and has a higher cleaning strength than the cleaning mode using chemicals described above, offline chemical cleaning with a higher cleaning strength than CIP, and the like. That is, the examples of the determination model M may include a determination model for learning the relationship between the water quality information of the water to be treated, the pressure to supply the water to be treated to the membrane filtration device, the transmembrane pressure, the permeation flux, the frequency of cleaning with cleaning water (filtered water), the supply amount and pressure of cleaning water (filtered water), the frequency of cleaning the filtration membrane with chemicals, and information on chemicals to be used when the filtration membrane is cleaned with the chemicals, and determining the optimum value of a current permeation flux, the frequency and cleaning conditions at which the membrane filtration device needs to be cleaned with cleaning water in the future, the frequency at which CIP or offline chemical cleaning needs to be performed on the membrane filtration device in the future, and the information on chemicals to be used when CIP or offline chemical cleaning is performed on the membrane filtration device based on the water quality information of the water to be treated, the pressure to supply the water to be treated to the membrane filtration device, and the transmembrane pressure at the filtration membrane.

In addition, the examples of the determination model M may also include a determination model for learning the relationship between the water quality information of the water to be treated, the pressure to supply the water to be treated to the membrane filtration device, the transmembrane pressure, the permeation flux, the frequency of cleaning with cleaning water (filtered water), the supply amount and pressure of cleaning water (filtered water), the frequency of cleaning the filtration membrane with chemicals, and information on chemicals to be used when the filtration membrane is cleaned with the chemicals, and determining the optimum value of a current permeation flux, the frequency and cleaning conditions at which the membrane filtration device needs to be cleaned with cleaning water in the future, and a time at which the filtration membrane of the membrane filtration device needs to be replaced based on the water quality information of the water to be treated, the pressure to supply the water to be treated to the membrane filtration device, and the transmembrane pressure at the filtration membrane.

Based on an experimental design method when the determination model M is generated, it is preferable to learn the relationship between the plurality of pieces of data selected from the water quality information of the water to be treated, the pressure to supply the water to be treated to the membrane filtration device, the transmembrane pressure, the permeation flux, the frequency of cleaning with cleaning water (filtered water), the supply pressure of cleaning water (filtered water), the air pressure of compressed air, the frequency of cleaning the filtration membrane with chemicals, and the information on chemicals to be used when the filtration membrane is cleaned with the chemicals.

FIG. 7 shows an example of a method of generating the determination model M based on the experimental design method.

For the permeation flux applied in the filtration mode, a high flux and a low flux are selected within a range in which technical and economic validity of the membrane filtration device can be found. Filtration at the high flux increases the amount of permeated water, but requires a higher driving pressure to increase the pressure or TMP to supply the water to be treated to the membrane filtration device according to Darcy's law, and there is a possibility that the frequency of cleaning may be increased depending on the water quality, and thus economic efficiency may be degraded.

For physical backwash strength such as a water volume, a pressurized pressure, a presence or absence of compressed air (blower activation), an air volume of compressed air, and a pressure of compressed air of physical backwash to be applied in the backwash mode, a high physical backwash strength and a low physical backwash strength are selected within a range in which an effective discharge of membrane clogging substances, a pressure resistance of the system, and economic efficiency can be found. The high physical backwash strength enhances a cleaning effect, but lowers an operation rate of the filtration mode, lowers a recovery rate of the filtered water, and consumes an energy of the electric motor.

For the frequency of cleaning to be applied in the cleaning mode using chemicals, a high frequency and a low frequency are selected within a range in which a technical cleaning effect and economic efficiency of chemical consumption can be found. The high frequency can be expected to have a higher cleaning effect, but consumes more chemicals. In addition, it may lead to deterioration of a filtration membrane material according to the selection of the filtration membrane material and chemicals.

On the basis of the experimental design method, variables are changed as appropriate in a situation such as whether a permeation flux to be applied in the filtration mode is a high flux or a low flux, a pressurized pressure of the physical backwash to be applied in the backwash mode is a high pressure or a low pressure, and the frequency of cleaning using chemicals to be applied in the cleaning mode is a high frequency or a low frequency. Then, the determination model M is generated by learning the relationship between the water quality information of the water to be treated, the pressure to supply the water to be treated to the membrane filtration device, and an amount of change in the transmembrane pressure at the filtration membrane.

For example, in “Test 1” of FIG. 7, the determination model M is generated by setting variables as follows.

(1-1) The permeation flux to be applied in the filtration mode is a low flux. Here, the low flux may be, for example, a value that is about a lower limit of a recommended value of the permeation flux described in a filtration membrane catalog by a filtration membrane manufacturer.

(1-2) The physical backwash strength to be applied in the backwash mode is high. The “physical backwash strength” specifically means a degree of strength of the physical backwash to be applied in the backwash mode, determined by one or more physical conditions selected from an amount of water in a cleaning solution, a pressurized pressure of the cleaning solution, the amount of compressed air, and the air pressure of the compressed air. “High physical backwash strength” specifically means conditions such as a large amount of water in the cleaning solution, a high pressurized pressure of the cleaning solution, a large amount of compressed air, or a high air pressure of the compressed air.

(1-3) The frequency of cleaning using chemicals to be applied in the cleaning mode is a high frequency. For example, it is set to the number of times to be assumed when raw water with many impurities and high-load water quality is processed.

In “Test 2” of FIG. 7, the determination model M is generated by setting variables as follows.

(2-1) The permeation flux to be applied in the filtration mode is a high flux. Here, the high flux is, for example, an upper limit at which the water to be treated does not overload the filtration membrane. In addition, it may be a value that is about an upper limit of a recommended value of the permeation flux described in the filtration membrane catalog by the filtration membrane manufacturer.

(2-2) The physical backwash strength to be applied in the backwash mode is high.

(2-3) The frequency of cleaning using chemicals to be applied in the cleaning mode is a high frequency.

In “Test 3” of FIG. 7, the determination model M is generated by setting variables as follows.

(3-1) The permeation flux to be applied in the filtration mode is a high flux.

(3-2) The physical backwash strength to be applied in the backwash mode is low. Specifically, it means conditions such as a small amount of water in the cleaning solution, a low pressurized pressure of the cleaning solution, a small amount of compressed air, or a low air pressure of the compressed air.

(3-3) The frequency of cleaning using chemicals to be applied in the cleaning mode is a high frequency.

In “Test 4” of FIG. 7, the determination model M is generated by setting variables as follows.

(4-1) The permeation flux to be applied in the filtration mode is a high flux.

(4-2) The physical backwash strength to be applied in the backwash mode is low.

(4-3) The frequency of cleaning using chemicals to be applied in the cleaning mode is a low frequency. For example, it is set to the number of times to be assumed when raw water of water quality with small amounts of impurities and a low load is processed.

The determining section 315b uses the determination model M stored in the storage 314 (the determination model M generated in the learning section 315a) to determine the optimum operation conditions of the water treatment apparatus 100 from the viewpoint of energy saving.

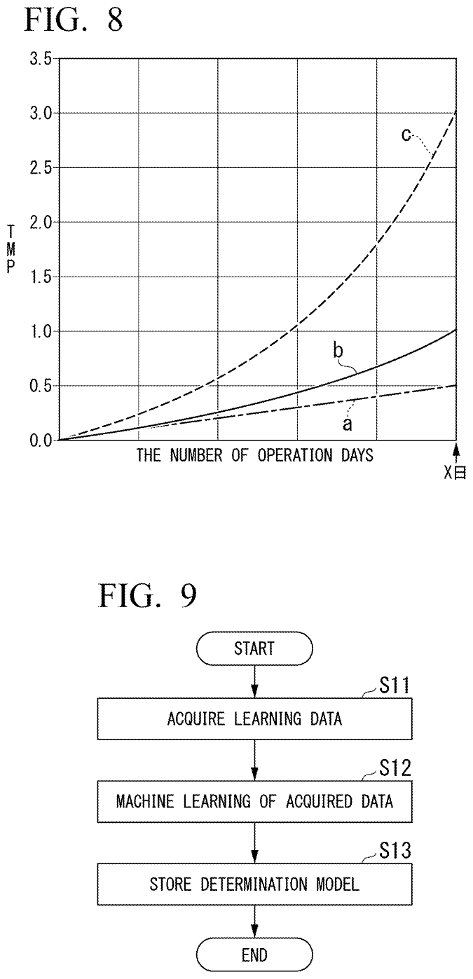

FIG. 8 is an example of support information displayed on the display 312. The number of days of filtration is shown on an X axis, and the transmembrane pressure (TMP) is shown on a Y axis. A full scale (X days) of the axis of the number of days of filtration indicates several days to about half a year in which the filtration mode, the backwash mode, the cleaning mode using chemicals, and the operation preparation mode are continuously repeated online.

Examples of the support information displayed on the display 312 include, for example, information on a need to perform online chemical cleaning (CIP), offline chemical cleaning with a higher cleaning strength than the CIP, membrane replacement, or the like when a continuous operation is stopped in X days. More specifically, it is as shown below.

That is, when a line a in FIG. 8 is displayed, it is known that a convergence value of TMP and reversibility of TMP can be found in the backwash mode and the cleaning mode using chemicals. Therefore, when a continuous operation is stopped in X days, CIP is performed with an emphasis on membrane clogging prevention and system inspection.

When a line b is displayed, it can be found that a constant continuous operation can be performed in the backwash mode and the cleaning mode using chemicals, but the convergence value of TMP cannot be found. Therefore, when the continuous operation is stopped in X days, it is known that CIP needs to be performed by finding conditions that enhance a recovery effect of the membrane using the CIP while paying attention to cleaning conditions (types, concentrations, immersion time, and the like of chemicals).

If a line c is displayed, irreversibility of TMP is significant under current operating conditions, and there is a possibility that the recovery of the membrane by CIP cannot be found, and, for example, when the continuous operation is stopped in X days, it is known that there is a need for offline cleaning of the membrane or replacement of the membrane filtration device. In addition, it is necessary to reconsider the operation conditions of the filtration mode, the backwash mode, and the cleaning mode using chemicals.

In addition, the examples of the support information displayed on the display 312 include, for example, an optimum value of a current permeation flux described above, a frequency and cleaning conditions at which the membrane filtration device needs to be cleaned with cleaning water in the future, a frequency at which the membrane filtration device needs to be cleaned with chemicals in the future, information on chemicals to be used when the membrane filtration device is cleaned with the chemicals in the future, and the like. If the operation manager operates the water treatment apparatus on the basis of such support information, it is possible to operate the water treatment apparatus that can find the convergence value of TMP as shown by the line a in FIG. 8 for a long period of time. In addition, a frequency of CIP or the like, which is performed by stopping the continuous operation can be reduced.

Such a support device 300 is realized by, for example, a desktop computer, a laptop computer, or a tablet computer. When the support device 300 is realized by a computer, functions of the support device 300 (for example, learning sections 315a and 315b) are realized by a program for realizing each function being executed by a CPU (central processing unit) provided in the computer. In other words, the support device 300 is realized through software and hardware resources in cooperation.

Here, the program that realizes the functions of the support device 300 may be distributed in a state of being recorded on a computer-readable recording medium such as a CD (registered trademark)-ROM or a DVD (registered trademark)-ROM, and may also be distributed via a network such as the Internet. The support device 300 may be realized using hardware such as a field-programmable gate array (FPGA), large scale integration (LSI), an application specific integrated circuit (ASIC), and the like.

According to the support device 300 described above, since the optimum operation conditions of the water treatment apparatus 100 can be presented to the operation manager based on data of the water to be treated such as water quality and current process data such as a permeation flux, it is possible to support the operation manager so that the control for optimum water treatment can be performed.

In addition, according to the support device 300, since the backwash mode and/or the cleaning mode using chemicals can be optimized, energy saving of the pressure pump used in the backwash mode and/or reduction in the amount of chemicals used in the cleaning mode using chemicals can be performed. Therefore, in addition to a stable supply of treated water, the cost of water treatment can be greatly reduced.

In addition, according to the support device 300, when external environmental factors closely related to transition of population, weather conditions, and the water quality of the water to be treated change over time, or even when the water quality of the water to be treated changes significantly in a short period of time due to sudden torrential rains, and the like, it is possible to easily optimize the control of the water treatment apparatus in real time.

Although the support device 300 includes the learning section 315a, the learning section may be another device. In other words, a learning process may be performed in a cloud or other devices dedicated to learning, and only results of the learning may be downloaded to the support device.

<Support Method>

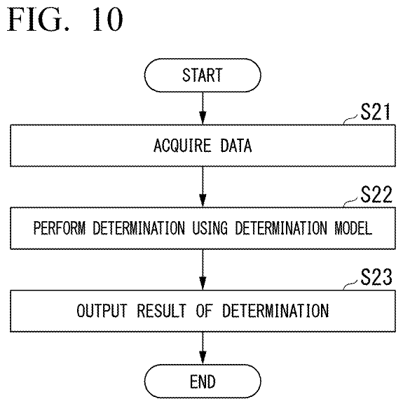

Details of a support method of the present embodiment will be described using FIGS. 9 and 10.

FIG. 9 is a flowchart at the time of learning.

In the support method of the present embodiment, at the time of learning, first, a learning data acquiring step S11 for acquiring data for learning is performed. Examples of the data for learning specifically include water quality information of the water to be treated, the pressure to supply the water to be treated to the membrane filtration device, the transmembrane pressure at the filtration membrane, the permeation flux (gfd or lmh) at the filtration membrane, the frequency of cleaning the filtration membrane with cleaning water (filtered water), the amount or the supply pressure of cleaning water (filtered water), the air pressure when the filtration membrane is cleaned with compressed air, the frequency of cleaning the filtration membrane with chemicals (the frequency of the cleaning mode using chemicals), information on chemicals to be used when the filtration membrane is cleaned with the chemicals (types, concentrations, and the like of chemicals.), and the like.

More specifically, the examples of the water quality information of the water to be treated include turbidity, pH, electrical conductivity, a water temperature, transmittance of ultraviolet rays with a wavelength of 254 nm (UV₂₅₄), residual chlorine (free chlorine and/or combined chlorine), total organic carbon (TOC), and information on types and concentrations of algae, cyanobacteria, plankton, protozoa, and the like.

Next, a learning process S12 for learning the data acquired in the learning data acquiring step S11 will be performed. Various algorithms such as various regression analysis methods, decision trees, k-neighborhood methods, neural networks, support vector machines, and the like can be used as learning algorithms in the learning process.

Next, a storing step S13 for storing the determination model obtained by the learning process S12 will be performed. The determination model is the same as the determination model M described above.

FIG. 10 is a flowchart at the time of operation.

In the support method of the present embodiment, at the time of operation, first, an acquiring step S21 for acquiring data for determination is performed.

Specifically, examples of the data for determination include the water quality information of the water to be treated, the pressure to supply the water to be treated to the membrane filtration device, and the transmembrane pressure at the filtration membrane.

Next, a determining step S22 will be performed in which determination is made using a determination model based on data acquired in the acquiring step S21.

Next, an outputting step S23 for outputting a determination result is performed.

For example, in the learning data acquiring step S11, when the water quality information of the water to be treated, the pressure to supply the water to be treated to the membrane filtration device, the transmembrane pressure at the filtration membrane, the permeation flux at the filtration membrane (gfd or lmh), the frequency of cleaning the filtration membrane with cleaning water (filtered water), and cleaning conditions are acquired, if the water quality information of the treated water, the pressure to supply the water to be treated to the membrane filtration device, and the transmembrane pressure at the filtration membrane are acquired in the acquiring step S21, the optimum value of a current permeation flux as well as the frequency and cleaning conditions at which the membrane filtration device needs to be cleaned with cleaning water in the future are output as the data for learning.

Examples of the cleaning conditions for cleaning the membrane filtration device with cleaning water include the supply amount and supply pressure of cleaning water when the membrane filtration device is cleaned with cleaning water, the temperature of cleaning water, the cleaning time, and the like, the presence or absence of the compressed air (blower activation), the amount of compressed air, the pressure of compressed air, and the like.

For example, in the learning data acquiring step S11, when the water quality information of the water to be treated, the pressure to supply the water to be treated to the membrane filtration device, the transmembrane pressure at the filtration membrane, the permeation flux at the filtration membrane (gfd or lmh), the frequency of cleaning the filtration membrane with cleaning water (filtered water), the cleaning conditions, the frequency of cleaning the filtration membrane with chemicals (the frequency of the cleaning mode using chemicals), and the information on chemicals to be used when the filtration membrane is cleaned with chemicals are acquired, if the water quality information of the treated water, the pressure to supply the water to be treated to the membrane filtration device, and the transmembrane pressure at the filtration membrane are acquired in the acquiring step S21, the optimum value of a current permeation flux, the frequency and cleaning conditions at which the membrane filtration device needs to be cleaned with cleaning water in the future, the frequency at which the membrane filtration device needs to be cleaned with chemicals in the future, and the information on chemicals to be used when the membrane filtration device is cleaned with the chemicals are output as the data for learning.

The information on chemicals includes types of chemicals, combinations of chemicals, concentrations of chemicals, and the like.

In addition, cleaning the filtration device with chemicals includes not only the cleaning mode using chemicals described above, but also the CIP and offline chemical cleaning described above.

For example, in the learning data acquiring step S11, when the water quality information of the water to be treated, the pressure to supply the water to be treated to the membrane filtration device, the transmembrane pressure difference at the filtration membrane, the permeation flux at the filtration membrane (gfd or lmh), the frequency of cleaning the filtration membrane with cleaning water (filtered water), the cleaning conditions, the frequency of cleaning the filtration membrane with chemicals (the frequency of the cleaning mode using chemicals), and the information on chemicals to be used when the filtration membrane is cleaned with chemicals are acquired, if the water quality information of the treated water, the pressure to supply the water to be treated to the membrane filtration device, and the transmembrane pressure at the filtration membrane are acquired in the acquiring step S21, the optimum value of a permeation flux, the frequency and cleaning conditions at which the membrane filtration device needs to be cleaned with cleaning water in the future, and information on the time at which the filtration membrane of the membrane filtration device needs to be replaced are output as the data for learning.

According to the support method of the present embodiment described above, since the optimum operation conditions of the water treatment apparatus can be presented to the operation manager based on data of the water to be treated such as water quality and current process data such as a permeation flux, it is possible to support the operation manager so that the control for optimum water treatment can be performed.

Further, according to the support method of the present embodiment, since the backwash mode and/or the cleaning mode using chemicals can be optimized, energy saving of the pressure pump used in the backwash mode and/or reduction in the amount of chemicals used in the cleaning mode using chemicals can be performed. Therefore, in addition to a stable supply of treated water, the cost of water treatment can be greatly reduced.

In addition, according to the support method of the present embodiment, when the external environmental factors closely related to transition of population, weather conditions, and the water quality of the water to be treated change over time, or even when the water quality of the water to be treated changes significantly in a short period of time due to sudden torrential rains, and the like, it is possible to easily optimize the control of the water treatment apparatus in real time.

Terms indicating directions such as “front, back, up, down, right, left, vertical, horizontal, longitudinal, transverse, rows and columns” herein refer to these directions in the device of the present invention. Accordingly, these terms in the specification of the present invention should be interpreted relatively in the device of the present invention.

A term “configured” refers to being configured to perform functions of the present invention, or is used to indicate a configuration, an element, or a portion of a device.

Furthermore, terms expressed as “means plus function” in the claim should include any structure that can be used to perform the functions included in the present invention.

A term “unit” is used to indicate a component, unit, a part of hardware or software programmed to perform a desired function. Typical examples of hardware are devices and circuits, but the present invention is not limited to these.

Although preferred embodiments of the invention have been described above, the invention is not limited to these embodiments. Additions, omissions, substitutions, and other changes of the configuration can be made within a range not departing from the gist of the present invention. The present invention is not limited by the description made above, but only by the scope of the accompanying claims.

### REFERENCE SIGNS LIST

1 Water treatment system
100 Water treatment apparatus
10 Feed tank
12 Strainer
14 Membrane filtration device
16 Filtrate tank
18 Chemical solution tank
20 Acid component tank
22 Basic component tank
24 Sodium hypochlorite tank
26 Reducing agent tank
28 Waste liquid tank
200 Controller
300 Support device
311 Operation device
312 Display
313 Communication device
314 Storage
315 Calculator
S11 Learning data acquiring step
S12 Learning step
S13 Storing step
S21 Acquiring step
S22 Determining step
S23 Outputting step

1. A support device for supporting an operation manager of a water treatment apparatus having a membrane filtration device with a filtration membrane, the support device comprising:
an acquirer configured to acquire data indicating water quality information of water to be treated, a pressure to supply the water to be treated to the membrane filtration device, a transmembrane pressure at the filtration membrane, a permeation flux at the filtration membrane, a frequency and cleaning conditions for cleaning the filtration membrane with cleaning water; and
an outputter configured to output an optimum value of a current permeation flux, and a frequency and cleaning conditions for cleaning the membrane filtration device with the cleaning water in the future based on the data indicating the water quality information of the water to be treated, the pressure to supply the water to be treated to the membrane filtration device, and the transmembrane pressure at the filtration membrane, that have been acquired by the acquirer, by using a learned determination model acquired by performing learning processing using the data acquired by the acquirer.

2. The support device according to claim 1,
wherein the acquirer is configured to further acquire data indicating a frequency for cleaning the filtration membrane with chemicals and information on chemicals to be used when the filtration membrane is cleaned with the chemicals,
wherein the determination model is further obtained by performing learning processing using data indicating a frequency for cleaning the filtration membrane with chemicals and information on chemicals to be used when the filtration membrane is cleaned with the chemicals, and
wherein the outputter is configured to further output a frequency for cleaning the membrane filtration device with chemicals in the future and information on chemicals to be used when the membrane filtration device is cleaned with the chemicals.

3. The support device according to claim 1, further comprising:
a learning section configured to acquire the determination model by performing the learning processing using the data acquired by the acquirer.

4. The support device according to claim 1,
wherein the cleaning conditions comprise supply pressure of cleaning water when the membrane filtration device is cleaned with cleaning water.

5. The support device according to claim 1,
wherein the determination model is a model for determining a frequency at which online chemical cleaning or offline chemical cleaning needs to be performed on the membrane filtration device in the future, and information on chemicals to be used when the online chemical cleaning or the offline chemical cleaning is performed on the membrane filtration device.

6. The support device according to claim 1,
wherein the determination model is a model for determining a time at which the filtration membrane of the membrane filtration device needs to be replaced.

7. The support device according to claim 1,
wherein the outputter is configured to output a graph indicating a relationship between a number of days of filtration and the transmembrane pressure as support information.

8. A support method for supporting an operation manager of a water treatment apparatus having a membrane filtration device with a filtration membrane, the support method comprising:
an acquiring step of acquiring data indicating water quality information of water to be treated, a pressure to supply the water to be treated to the membrane filtration device, a transmembrane pressure at the filtration membrane, a permeation flux at the filtration membrane, a frequency and cleaning conditions for cleaning the filtration membrane with cleaning water; and
an outputting step of outputting an optimum value of a current permeation flux, and a frequency and cleaning conditions for cleaning the membrane filtration device with cleaning water in the future based on the data indicating the water quality information of the water to be treated, the pressure to supply the water to be treated to the membrane filtration device, and the transmembrane pressure at the filtration membrane, that have been acquired in the acquiring step, by using a learned determination model acquired by performing learning processing using the data acquired in the acquiring step.

9. The support method according to claim 8,
wherein the acquiring step comprises further acquiring data indicating a frequency for cleaning the filtration membrane with chemicals and information on chemicals to be used when the filtration membrane is cleaned with the chemicals,
wherein the determination model is further obtained by performing learning processing using data indicating a frequency for cleaning the filtration membrane with chemicals and information on chemicals to be used when the filtration membrane is cleaned with the chemicals, and
wherein the outputting step comprises further outputting a frequency for cleaning the membrane filtration device with chemicals in the future and information on chemicals to be used when the membrane filtration device is cleaned with the chemicals.

10. The support method according to claim 8, further comprising:
a learning step of acquiring the determination model by performing the learning processing using the data acquired in the acquiring step.

11. The support method according to claim 8,
wherein the cleaning conditions comprise supply pressure of cleaning water when the membrane filtration device is cleaned with cleaning water.

12. The support method according to claim 8,
wherein the determination model is a model for determining a frequency at which online chemical cleaning or offline chemical cleaning needs to be performed on the membrane filtration device in the future, and information on chemicals to be used when the online chemical cleaning or the offline chemical cleaning is performed on the membrane filtration device.

13. The support method according to claim 8,
wherein the determination model is a model for determining a time at which the filtration membrane of the membrane filtration device needs to be replaced.

14. The support method according to claim 8,
wherein the outputting step comprises outputting a graph indicating a relationship between a number of days of filtration and the transmembrane pressure as support information.

15. A non-transitory computer readable storage medium storing a support program for causing a computer of a support device for supporting an operation manager of a water treatment apparatus having a membrane filtration device with a filtration membrane to execute:
an acquiring step of acquiring data indicating water quality information of water to be treated, a pressure to supply the water to be treated to the membrane filtration device, a transmembrane pressure at the filtration membrane, a permeation flux at the filtration membrane, a frequency and cleaning conditions for cleaning the filtration membrane with cleaning water; and
an outputting step of outputting an optimum value of a current permeation flux, and a frequency and cleaning conditions for cleaning the membrane filtration device with cleaning water in the future based on the data indicating the water quality information of the water to be treated, the pressure to supply the water to be treated to the membrane filtration device, and the transmembrane pressure at the filtration membrane, that have been acquired in the acquiring step, by using a learned determination model acquired by performing learning processing using the data acquired in the acquiring step.

16. The non-transitory computer readable storage medium according to claim 15,
wherein the acquiring step comprises further acquiring data indicating a frequency for cleaning the filtration membrane with chemicals and information on chemicals to be used when the filtration membrane is cleaned with the chemicals,
wherein the determination model is further obtained by performing learning processing using data indicating a frequency for cleaning the filtration membrane with chemicals and information on chemicals to be used when the filtration membrane is cleaned with the chemicals, and
wherein the outputting step comprises further outputting a frequency for cleaning the membrane filtration device with chemicals in the future and information on chemicals to be used when the membrane filtration device is cleaned with the chemicals.

17. The non-transitory computer readable storage medium according to claim 15, wherein the support program further causes the computer to execute:
a learning step of acquiring the determination model by performing the learning processing using the data acquired in the acquiring step.

18. The non-transitory computer readable storage medium according to claim 15,
wherein the cleaning conditions comprise supply pressure of cleaning water when the membrane filtration device is cleaned with cleaning water.

19. The non-transitory computer readable storage medium according to claim 15,
wherein the determination model is a model for determining a frequency at which online chemical cleaning or offline chemical cleaning needs to be performed on the membrane filtration device in the future, and information on chemicals to be used when the online chemical cleaning or the offline chemical cleaning is performed on the membrane filtration device.

20. The non-transitory computer readable storage medium according to claim 15,
wherein the determination model is a model for determining a time at which the filtration membrane of the membrane filtration device needs to be replaced.
